(19) United States
(12) Patent Application Publication
(10) Pub. No.: US 2009/0125405 A1
(43) Pub. Date: May 14, 2009

(54) POINT OF SALE (POS) SYSTEM AND METHOD FOR CONTROLLING THE SAME

(75) Inventor: Jeon Sub Shin, Seoul (KR)

Correspondence Address: OHLANDT, GREELEY, RUGGIERO & PERLE, LLP, ONE LANDMARK SQUARE, 10TH FLOOR, STAMFORD, CT, 06901, US

(73) Assignee: CNP Technology Co., ltd

(21) Appl. No.: 12/295,593

(22) PCT Filed: Mar. 6, 2007
(86) PCT No.: PCT/KR2007/001096

§ 371 Date: Sep. 30, 2008

(30) Foreign Application Priority Data
Apr. 10, 2006 (KR) 1020060032367

(51) Int. Cl. G06Q 10/00; G06Q 30/00

(52) U.S. Cl. 705/22; 705/23; 705/25

(57) ABSTRACT

A point of sale (POS) system and a control method thereof are provided. The POS system comprises a bar code scanner scanning a bar code attached to the goods, a key input unit for selectively cancelling or shelving the scanned goods, a POS terminal receiving goods information from the bar code scanner or the key input unit, and a scan/key input indication unit having one or more indication lamps turned on in certain color through receiving a specified data signal from the POS terminal when the bar code scanner scans the bar code of goods, or the key input unit cancels or shelves the scanned goods whereby when a salesperson manipulates the key input unit so as to cancel or shelve the scanned goods by intention or by mistake after the bar code of goods is scanned, the corresponding indication lamp is turned on so that a manager or others as well as the salesperson recognizes the situation.

### TECHNICAL FIELD

The present invention relates to a point of sale (POS) system and a control method thereof, and more particularly to a point of sale (POS) system in which, when a salesperson scans a bar code of goods, or manipulates a key input unit so as to cancel or shelve the scanned goods, a corresponding indication lamp lights so that a manager or others as well as the salesperson recognizes the situation, and a control method thereof.

### BACKGROUND ART

A point of sale (POS) system managing point-of-sale data of goods includes a plurality of POS terminals that scan a bar code attached to goods to process receipts and payments for goods and manage sales data, and a host server connected with the POS terminals via a data communication network to process diverse data received from the respective POS terminals, thereby managing distribution economy comprehensively. Here, the POS terminal loads therein software for management of distribution economy such as receipts-and-payments management, sales management, sales analysis, or the like, and supports a data communication network access function for interworking with a host computer, a database server, or others.

To this end, a salesperson scans a bar code attached to the sales goods via a scanner connected to a POS terminal and inputs scanned information, so that the POS system can process receipts and payments through easy calculation of a cost of the goods and collect sales data as well to thereby manage gross sales, and can process payment receipts through settlement approval via a Value Added Network (VAN) by inputting credit card information via a card reader.

Like this, since the POS system facilitates management of diverse data regarding distribution and provides convenience in sales process, it is used in many places such as a convenience store, a general retail outlet, etc. as well as a superstore, e.g., department store, a discount store, etc.

Meanwhile, in sales processing, there may be often the case where during or after scanning the goods, a salesperson has to cancel or shelve the specified goods. For instance, the scanned goods may be cancelled due to a change of consumer's mind, or the scanned goods may have to be shelved by a salesperson himself/herself in the case where the goods are forbidden to sell to young people.

However, beside such the normal cancelling or shelving, the cancelling or the shelving may occur due to a salesperson's error or foul play, which causes operating losses by wrong calculation of receipt costs of the goods. In this case, there is no choice at present, but to operate the POS system, trusting the salesperson's conscience, so that it is required to take practical countermeasures against the problem.

### DISCLOSURE OF INVENTION

### Technical Problem

Accordingly, the present invention has been made to solve the above-mentioned problems occurring in the prior art, and an object of the present invention is to provide a point of sale (POS) system having a scan/key input indication unit in which, when a salesperson scans a bar code of goods, or when a salesperson cancels or shelves the goods being scanned or the goods already scanned, an indication lamp lights so that a manager or others as well as the salesperson recognizes the situation, and a control method thereof.

### Technical Solution

In order to accomplish the above object, there is provided a point of sale (POS) system for managing point-of-sale data of goods, the system comprising: a bar code scanner scanning a bar code attached to the goods; a key input unit for selectively cancelling or shelving the scanned goods; a POS terminal receiving goods information from the bar code scanner or the key input unit; and a scan/key input indication unit having one or more indication lamps turned on in certain color through receiving a specified data signal from the POS terminal when the bar code scanner scans the bar code of goods, or the key input unit cancels or shelves the scanned goods.

The scan/key input indication unit may include a single indication lamp that is not turned on when the bar code scanner scans the bar code of goods, but is turned on when the key input unit cancels or shelves the scanned goods.

The scan/key input indication unit may include a first indication lamp that is not turned on when the bar code scanner scans the bar code of goods, but is turned on when the key input unit cancels the scanned goods, and a second indication lamp that is turned on when the key input unit shelves the scanned goods.

The scan/key input indication unit may include a first indication lamp that is turned on when the bar code scanner scans the bar code of goods, and a second indication lamp that is turned on when the key input unit cancels or shelves the scanned goods.

The scan/key input indication unit may include a first indication lamp that is turned on when the bar code scanner scans the bar code of goods, a second indication lamp that is turned on when the key input unit cancels the scanned goods, and a third indication lamp that is turned on when the key input unit shelves the scanned goods.

The indication lamps may be turned on in different color from each other.

In accordance with another aspect of the present invention, there is provided a control method of a point of sale (POS) system, the method comprising the steps of: scanning a bar code attached to goods according to a request for goods sale from a purchaser; inputting a key by a salesperson for cancelling or shelving the scanned goods; and enabling an indication lamp to be turned on.

In accordance with an embodiment of the present invention, there is provided a control method of a point of sale (POS) system, the method comprising the steps of: scanning a bar code attached to goods according to a request for goods sale from a purchaser; inputting a key by a salesperson for cancelling or shelving the scanned goods; and enabling first and second indication lamps to be turned on when a goods-cancelling key and a goods-shelving key are input, respectively.

In accordance with an embodiment of the present invention, there is provided a control method of a point of sale (POS) system, the method comprising the steps of: scanning a bar code attached to goods according to a request for goods sale from a purchaser; enabling a first indication lamp to be turned on; inputting a key by a salesperson for cancelling or shelving the scanned goods; and enabling a second indication lamp to be turned on.

In accordance with an embodiment of the present invention, there is provided a control method of a point of sale (POS) system, the method comprising the steps of: scanning a bar code attached to goods according to a request for goods sale from a purchaser; enabling a first indication lamp to be turned on; inputting a key by a salesperson for cancelling or shelving the scanned goods; and enabling second and third indication lamps to be turned on when a goods-cancelling key and a goods-shelving key are input, respectively.

### ADVANTAGEOUS EFFECTS

According to the present invention, when a salesperson cancels or shelves the goods via the key input unit by intension or by mistake, the scan/key input unit turns on the indication lamp in specified color. From this, a manager or others as well as the salesperson can recognize the goods cancelling or shelving action, thereby previously preventing operation losses by salesperson's foul play, or error in sales calculation by mistake.

### BRIEF DESCRIPTION OF THE DRAWINGS

The above and other objects, features and advantages of the present invention will be more apparent from the following detailed description taken in conjunction with the accompanying drawings, in which:

FIG. 1 is a constructional view of a point of sale (POS) system according to an embodiment of the present invention;

FIG. 2 is a view illustrating diverse scan/key input units of the POS system according to an embodiment of the invention;

FIG. 3 is a flow chart of a control method of the POS system having the scan/key input unit (a) in FIG. 2 according to an embodiment of the invention;

FIG. 4 is a flow chart of a control method of the POS system having the scan/key input unit (b) in FIG. 2 according to an embodiment of the invention;

FIG. 5 is a flow chart of a control method of the POS system having the scan/key input unit (c) in FIG. 2 according to an embodiment of the invention; and

FIG. 6 is a flow chart of a control method of the POS system having the scan/key input unit (b) in FIG. 2 according to another embodiment of the invention.

### BEST MODE FOR CARRYING OUT THE INVENTION

Hereinafter, preferred embodiments of the present invention will be described with reference to the accompanying drawings.

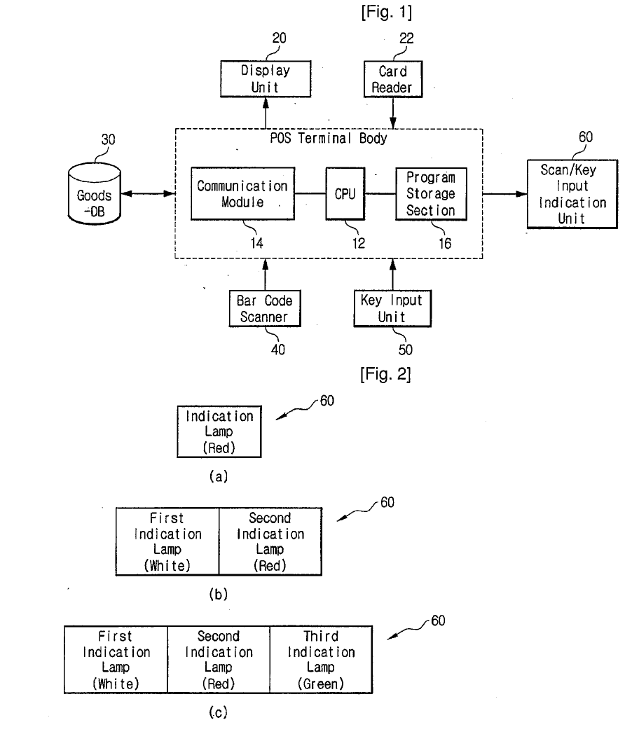

FIG. 1 is a constructional view of a point of sale (POS) system according to an embodiment of the present invention.

In FIG. 1, a point of sale (POS) system includes a POS terminal 10, a display unit 20, a card reader 22, a goods-database (DB) 30, a bar code scanner 40, a key input unit 50, and a scan/key input indication unit 60.

The POS terminal 10 is selectively connected with devices using a communication standard such as RS-232C, USB, PS2, etc., including the display unit 20, the card reader 22, the bar code scanner 40, the key input unit, or the like, which provides the POS terminal 10 with diverse data, or displays data provided from the POS terminal 10.

In addition, the POS terminal 10 includes a communication module 14 for sending/receiving data to/from the goods-DB 30, a peripheral device, etc., a program storage section 16 storing therein a program for distribution management such as sales, receipts and payments, stocks, approval, etc., and a CPU 12 executing the program stored in the program storage section 16 to control a general function for goods sale. The display unit 20 outputs diverse data processed by the POS terminal, such as general data including goods sales, a processing result of receipts and payments, etc, and a message indicating the cancelling or shelving the scanned goods.

The card reader 22 reads out card (e.g., credit card) data and provides it to the POS terminal 10, and can request a credit card company for authentication using the POS system via value added network (VAN).

The goods-DB 30 stores therein data for diverse goods. For instance, upon scanning a bar code, the POS terminal 10 receiving the scanned data information reads out goods information stored in the goods-DB 30 and displays the goods information, such as a price, a brand, etc., on the display unit 20.

The bar code scanner 40 scans a bar code attached to the sale goods and provides bar code data to the POS terminal 10.

In the case that during scanning the sale goods or after scanning all goods, the specified goods are cancelled or shelved, the key input unit 50 selects the goods among the goods displayed on the display unit 20 so as to cancel or shelve.

The scan/key input indication unit 60 is composed of at least one indication lamps connected with the POS terminal 10 to light in certain color. When the bar code scanner 40 scans a bar code of goods, or when the key input unit 50 cancels or shelves the specified goods, the indication lamp is turned on in specified color. Such a scan/key input indication unit 60 will be explained in detail with reference to FIG. 2.

FIG. 2 is a view illustrating diverse scan/key input units of the POS system according to an embodiment of the invention.

In FIG. 2, the scan/key input indication unit is composed of a single indication lamp (a), two indication lamps (b) consisting of a first lamp (white) and a second lamp (red), or three indication lamps (c) consisting of a first lamp (white), a second lamp (red), and a third lamp (green).

Here, although the lighting color of the lamps in FIG. 2 is exemplarily illustrated to be white, red, and green, the present invention is not limited thereto, and it is apparent to those skilled in the art that indication lamps lighting various different colors may be adapted as selected by designers.

In the construction (a) of the scan/key input indication unit 60, the indication lamp is not turned on when a bar code of goods is scanned, but is turned on when the goods are cancelled or shelved.

In the construction (b) of the scan/key input indication unit 60, the first indication lamp (white) is turned on when a bar code of goods is scanned, and the second indication lamp (red) is turned on when the goods are cancelled or shelved.

In the construction (c) of the scan/key input indication unit 60, the first indication lamp (white) is turned on when a bar code of goods is scanned, the second indication lamp (red) is turned on when the goods are cancelled, and the third indication lamp (green) is turned on when the goods are shelved.

In addition, in the construction (b) of the scan/key input indication unit 60, the indication lamp may not be turned on when a bar code of goods is scanned, the first indication lamp (white) may be turned on when the goods are cancelled, and the second indication lamp (red) may be turned on when the goods are shelved.

Like this, in the POS system according to the embodiment of the invention, when a salesperson cancels or shelves the goods via the key input unit 50 by intension or by mistake, the scan/key input unit 60 turns on the indication lamp in specified color. From this, a manager or others as well as the salesperson can recognize the goods cancelling or shelving action, thereby previously preventing operation losses by salesperson's foul play, or error in sales calculation by mistake.

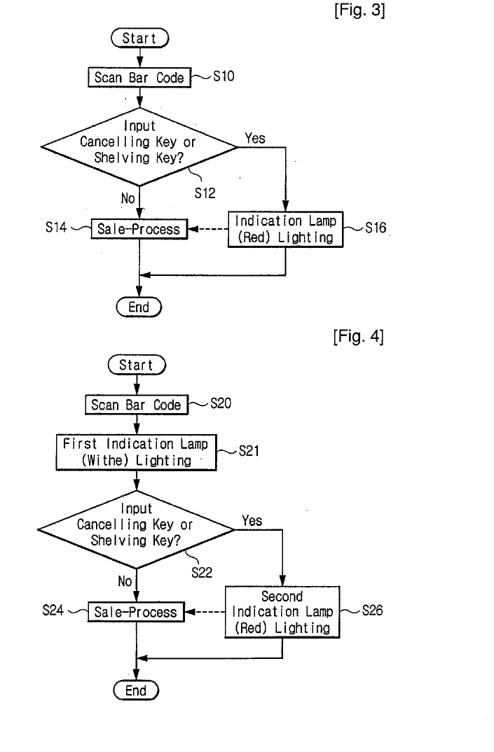

FIG. 3 is a flow chart of a control method of the POS system having the scan/key input unit (a) in FIG. 2 according to an embodiment of the invention.

In FIG. 3, first, a salesperson scans a bar code of goods by a bar code scanner 40 (S10).

During scanning the goods or after scanning all goods, it is determined whether or not a salesperson cancels or shelves the specified goods (S12) using the key input unit 50, and if not, the scanned goods are sale-processed (S14). In this case, an indication lamp of the scan/key input indication unit 60 is not turned on.

If a salesperson cancels or shelves the specified goods, the POS terminal 10 receives a cancelling or shelving data signal from the key input unit 50, and applies a lighting signal to the scan/key input indication unit 60, thereby turning on the indication lamp (red color) (S16).

FIG. 4 is a flow chart of a control method of the POS system having the scan/key input unit (b) in FIG. 2 according to an embodiment of the invention.

In FIG. 4, first, a salesperson scans a bar code of goods by a bar code scanner 40 (S20). Here, the POS terminal 10 receives a normal data signal and applies a first lighting signal to the scan/key input indication unit 60, thereby turning on a first indication lamp (white) (S21). The first indication lamp (white) is turned on whenever the respective bar codes of goods are scanned.

Next, during scanning the goods or after scanning all goods, it is determined whether or not a salesperson cancels or shelves the specified goods (S22) using the key input unit 50, and if not, the scanned goods are sale-processed (S24).

If a salesperson cancels or shelves the specified goods, the POS terminal 10 receives a cancelling or shelving data signal from the key input unit 50, and applies a second lighting signal to the scan/key input indication unit 60, thereby turning on a second indication lamp (red color) (S26).

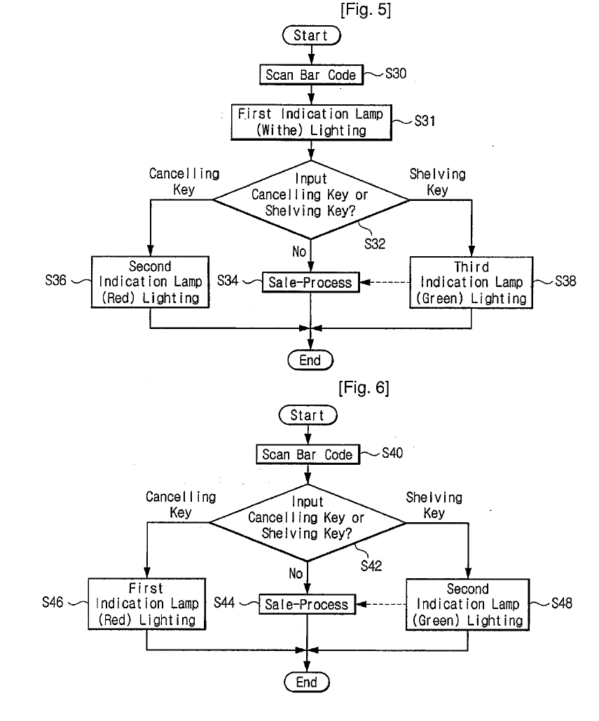

FIG. 5 is a flow chart of a control method of the POS system having the scan/key input unit (c) in FIG. 2 according to an embodiment of the invention.

In FIG. 5, first, a salesperson scans a bar code of goods by a bar code scanner 40 (S30). Here, the POS terminal 10 receives a normal data signal and applies a first lighting signal to the scan/key input indication unit 60, thereby turning on a first indication lamp (white) (S31). The first indication lamp (white) is turned on whenever the respective bar codes of goods are scanned.

Next, during scanning the goods or after scanning all goods, it is determined whether or not a salesperson cancels or shelves the specified goods (S32) using the key input unit 50, and if not, the scanned goods are sale-processed (S34).

If a salesperson cancels the specified goods, the POS terminal 10 receives a cancelling data signal from the key input unit 50, and applies a second lighting signal to the scan/key input indication unit 60, thereby turning on a second indication lamp (red color) (S36).

If a salesperson shelves the specified goods, the POS terminal 10 receives a shelving data signal from the key input unit 50, and applies a third lighting signal to the scan/key input indication unit 60, thereby turning on a third indication lamp (red color) (S38).

FIG. 6 is a flow chart of a control method of the POS system having the scan/key input unit (b) in FIG. 2 according to another embodiment of the invention.

In FIG. 6, first, a salesperson scans a bar code of goods by a bar code scanner 40 (S40).

During scanning the goods or after scanning all goods, it is determined whether or not a salesperson cancels or shelves the specified goods (S42) using the key input unit 50, and if not, the scanned goods are sale-processed (S44). In this case, an indication lamp of the scan/key input indication unit 60 is not turned on.

If a salesperson cancels the specified goods, the POS terminal 10 receives a cancelling data signal from the key input unit 50, and applies a first lighting signal to the scan/key input indication unit 60, thereby turning on a first indication lamp (red color) (S46).

If a salesperson shelves the specified goods, the POS terminal 10 receives a shelving data signal from the key input unit 50, and applies a second lighting signal to the scan/key input indication unit 60, thereby turning on a second indication lamp (green color) (S48).

In FIGS. 3 to 6, the shelved goods means for example the goods that are forbidden to be sold to young people, and in this case, it is determined whether or not the shelved goods are normally processed according to whether or not a consumer is authenticated to be an adult through authentication. If the consumer is determined to be an adult, the shelved goods are normally sale-processed, and if not, the shelved goods are cancelled so that the goods are excluded from sale.

Although preferred embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As set forth before, in the POS system and the control method thereof according to the present invention, when a salesperson cancels or shelves the goods via the key input unit 50 by intension or by mistake, the scan/key input unit 60 turns on the indication lamp in specified color. From this, a manager or others as well as the salesperson can recognize the goods cancelling or shelving action, thereby previously preventing operation losses by salesperson's foul play, or error in sales calculation by mistake.

1. A point of sale (POS) system for managing point-of-sale data of goods, the system comprising:
a bar code scanner scanning a bar code attached to the goods;
a key input unit for selectively cancelling or shelving the scanned goods;
a POS terminal receiving goods information from the bar code scanner or the key input unit; and
a scan/key input indication unit having one or more indication lamps turned on in certain color through receiving a specified data signal from the POS terminal when the bar code scanner scans the bar code of goods, or the key input unit cancels or shelves the scanned goods.

2. The POS system according to claim 1, wherein the scan/key input indication unit includes a single indication lamp that is not turned on when the bar code scanner scans the bar code of goods, but is turned on when the key input unit cancels or shelves the scanned goods.

3. The POS system according to claim 1, wherein the scan/key input indication unit includes:
a first indication lamp that is not turned on when the bar code scanner scans the bar code of goods, but is turned on when the key input unit cancels the scanned goods; and
a second indication lamp that is turned on when the key input unit shelves the scanned goods.

4. The POS system according to claim 1, wherein the scan/key input indication unit includes:
a first indication lamp that is turned on when the bar code scanner scans the bar code of goods; and
a second indication lamp that is turned on when the key input unit cancels or shelves the scanned goods.

5. The POS system according to claim 1, wherein the scan/key input indication unit includes:
a first indication lamp that is turned on when the bar code scanner scans the bar code of goods;
a second indication lamp that is turned on when the key input unit cancels the scanned goods; and
a third indication lamp that is turned on when the key input unit shelves the scanned goods.

6. The POS system according to claim 3, wherein the indication lamps are turned on in different color from each other.

7. A control method of a point of sale (POS) system for managing point-of-sale data of goods, the method comprising the steps of:
scanning a bar code attached to goods according to a request for goods sale from a purchaser;
inputting a key by a salesperson for cancelling or shelving the scanned goods; and
enabling an indication lamp to be turned on.

8. A control method of a point of sale (POS) system for managing point-of-sale data of goods, the method comprising the steps of:
scanning a bar code attached to goods according to a request for goods sale from a purchaser;
inputting a key by a salesperson for cancelling or shelving the scanned goods; and
enabling first and second indication lamps to be turned on when a goods-cancelling key and a goods-shelving key are input, respectively.

9. A control method of a point of sale (POS) system for managing point-of-sale data of goods, the method comprising the steps of:
scanning a bar code attached to goods according to a request for goods sale from a purchaser;
enabling a first indication lamp to be turned on;
inputting a key by a salesperson for cancelling or shelving the scanned goods; and
enabling a second indication lamp to be turned on.

10. A control method of a point of sale (POS) system for managing point-of-sale data of goods, the method comprising the steps of:
scanning a bar code attached to goods according to a request for goods sale from a purchaser;
enabling a first indication lamp to be turned on;
inputting a key by a salesperson for cancelling or shelving the scanned goods; and
enabling second and third indication lamps to be turned on when a goods-cancelling key and a goods-shelving key are input, respectively.

11. The POS system according to claim 4, wherein the indication lamps are turned on in different color from each other.

12. The POS system according to claim 5, wherein the indication lamps are turned on in different color from each other.
